(19) United States
(12) Patent Application Publication
(10) Pub. No.: US 2011/0311728 A1
(43) Pub. Date: Dec. 22, 2011

(54) STABILIZER COMPOSITION FOR POLYAMIDES

(76) Inventors: Harald OTT, Freiberg Am Neckar (DE); Gerald KAMMER, Ludwigsburg (DE)

(21) Appl. No.: 13/114,706

(22) Filed: May 24, 2011

(30) Foreign Application Priority Data
Jun. 17, 2010 (DE) 102010030212.0

(51) Int. Cl. C08K 3/16; C09K 15/02; B05D 3/12; C08L 77/00

(52) U.S. Cl. 427/367; 524/413; 252/400.53

(57) ABSTRACT

A polymer composition containing at least one thermoplastic polymer, in particular polyamide. To reduce the formation of conductive deposits on a metal or metal-plastic composite 10 coated and/or extrusion coated using the polymer composition, the polymer composition contains at least one copper halide and at least one alkali halide.

### FIELD OF THE INVENTION

The present invention relates to a stabilizer composition for stabilizing thermoplastic polymers, in particular polyamides as well as polymer compositions of this type.

### BACKGROUND INFORMATION

With the pressed screen applications currently known for transmission control modules, the development of conductive deposits on plastic sheathed pressed screens occurs often in oil storage tests and/or during operation and may cause short circuits or shunts and therefore false alarms and failures.

### SUMMARY OF THE INVENTION

The subject matter of the present invention is a polymer composition containing at least one thermoplastic polymer, at least one copper halide and at least one alkali halide. The polymer composition may in particular contain (as a thermoplastic polymer) at least one polyamide, for example, PA66.

The polymer composition according to the present invention has the advantage that the formation of conductive deposits on a metal coated using the polymer composition according to the present invention may be reduced, delayed or even prevented. It is therefore advantageously possible to omit additional cost-intensive measures such as applying multiple polymeric and/or galvanic layers.

The polymer composition may contain, for example, at least one copper halide selected from the group including copper(I) fluoride, copper(I) chloride, copper(I) bromide, copper(I) iodide, copper(II) fluoride, copper(II) chloride, copper(II) bromide and copper(II) iodide.

Within the scope of one specific embodiment, the polymer composition includes at least one copper(I) halide. Copper(I) halides have proven advantageous for stabilizing thermoplastic polymers, in particular polyamides. For example, the stabilizer composition may contain at least one copper halide selected from the group including copper(I) fluoride, copper(I) chloride, copper(I) bromide and copper(I) iodide.

Within the scope of an additional specific embodiment, the polymer composition contains copper(I) iodide. Copper(I) iodide has proven to be particularly advantageous for stabilizing thermoplastic polymers, in particular polyamides.

The polymer composition may contain, for example, at least one alkali halide selected from the group including lithium fluoride, lithium chloride, lithium bromide, lithium iodide, sodium fluoride, sodium chloride, sodium bromide, sodium iodide, potassium fluoride, potassium chloride, potassium bromide and potassium iodide.

The alkali halide may be used in particular to supply new halide ions to a copper halide whose halide ions are consumed over time. For this purpose, it has proven advantageous if the copper halides and the alkali halides of the polymer composition have the same type of halogen. For example, the polymer composition may contain a copper fluoride and an alkali fluoride and/or a copper chloride and an alkali chloride and/or a copper bromide and an alkali bromide and/or a copper iodide and an alkali iodide, in particular a copper iodide and an alkali iodide. The polymer composition may have a molar ratio of copper halides to alkali halides, for example, of copper fluoride to alkali fluoride or of copper fluoride to alkali fluoride or of copper bromide to alkali bromide or of copper iodide to alkali iodide, in particular of copper(I) iodide to potassium iodide in a range from 1:3 to 1:115, for example, from 1:12 to 1:115 or from 1:17 to 1:115 and/or a weight ratio of copper halides to alkali halides, for example, of copper fluoride to alkali fluoride or of copper fluoride to alkali chloride or of copper bromide to alkali bromide or of copper iodide to alkali iodide, in particular of copper(I) iodide to potassium iodide in a range of 1:2.5 to 1:100, for example, from 1:11 to 1:100 or from 1:15 to 1:100.

The polymer composition may contain in particular at least one alkali iodide selected from the group including lithium iodide, sodium iodide and potassium iodide, for example.

Within the scope of an additional specific embodiment, the polymer composition contains potassium iodide. Potassium iodide may diffuse out of the polymer matrix and be deposited on adjacent metallic areas or it may react with the metal (migration effects). These compounds, which are not detectable because of their small layer thickness, have a great influence on the subsequent corrosive and reactive behavior.

Within the scope of an additional specific embodiment, the sum of the proportions of copper halides, for example, copper(I) iodide and alkali halides, for example, potassium iodide, in the polymer composition, based on the total weight of the polymer composition, is ≧0.01 wt % to ≦10 wt %, preferably ≧1.1 wt % to ≦10 wt % or ≧1.15 wt % to ≦10 wt %, for example, ≧1.15 wt % to ≦3.5 wt % or ≧1.65 wt % to ≦3.5 wt %. This has proven to be particularly advantageous for stabilizing thermoplastic polymers, in particular polyamides.

Within the scope of an additional specific embodiment, the proportion of copper halides, for example, copper(I) iodide in the polymer composition amounts to ≧0.1 wt % to ≦1 wt %, in particular ≧0.15 wt % to ≦1 wt % or ≧0.2 wt % to ≦1 wt %, for example, ≧0.15 wt % to ≦0.5 wt % or ≧0.2 wt % to ≦0.5 wt %, based on the total weight of the polymer composition and/or the proportion of alkali halides, for example, potassium iodide, in the polymer composition amounts to ≧1 wt % to ≦9 wt %, in particular ≧1.5 wt % to ≦9 wt % or ≧2 wt % to ≦9 wt %, for example, ≧1.5 wt % to ≦3 wt % or ≧2 wt % to ≦3 wt %, based on the total weight of the polymer composition. This has also proven to be particularly advantageous for stabilizing thermoplastic polymers, in particular polyamides. For example, the polymer composition may contain approximately ≧0.1 wt % to ≦0.2 wt % copper(I) iodide and approximately ≧1 wt % to ≦2 wt % potassium iodide, each based on the total weight of the polymer composition.

Furthermore, the polymer composition may contain at least one reinforcing agent, for example, fibers, in particular glass fibers. The polymer composition may contain approximately ≧0.01 wt % to ≦50 wt % glass fibers, for example.

The polymer composition may be in particular an extrusion coating material or injection molding granules, in particular a pressed screen extrusion coating material.

Another subject matter of the present invention is a stabilizer composition for stabilizing thermoplastic polymers containing at least one copper halide (as a stabilizer) and at least one alkali halide (as a costabilizer).

The stabilizer composition according to the present invention has the advantage that the formation of conductive deposits on a metal coated with a suitably stabilized polymer composition is reduced, delayed or even prevented. It is therefore advantageously possible to omit additional cost-intensive measures such as applying multiple polymeric and/or galvanic layers.

The stabilizer composition may contain at least one copper halide selected from the group including copper(I) fluoride, copper(I) chloride, copper(I) bromide, copper(I) iodide, copper(II) fluoride, copper(II) chloride, copper(II) bromide and copper(II) iodide.

Within the scope of one specific embodiment, the stabilizer composition contains at least one copper(I) halide. Copper(I) halides have proven advantageous for stabilizing thermoplastic polymers, in particular polyamides. For example, the stabilizer composition may contain at least one copper halide selected from the group including copper(I) fluoride, copper(I) chloride, copper(I) bromide and copper(I) iodide.

Within the scope of an additional specific embodiment, the stabilizer composition contains copper(I) iodide. Copper(I) iodide has proven to be advantageous in particular for stabilizing thermoplastic polymers, in particular polyamides.

The stabilizer composition may contain, for example, at least one alkali halide selected from the group including lithium fluoride, lithium chloride, lithium bromide, lithium iodide, sodium fluoride, sodium chloride, sodium bromide, sodium iodide, potassium fluoride, potassium chloride, potassium bromide and potassium iodide.

The alkali halide may be used in particular to supply new halide ions to a copper halide whose halide ions have been consumed over time. It has proven advantageous here if the copper halides and the alkali halides of the stabilizer composition have the same type of halogen. For example, the stabilizer composition may contain a copper fluoride and an alkali fluoride and/or a copper chloride and an alkali chloride and/or a copper bromide and an alkali bromide and/or a copper iodide and an alkali iodide, in particular a copper iodide and an alkali iodide.

The stabilizer composition may contain in particular at least one alkali iodide, for example, selected from the group including lithium iodide, sodium iodide and potassium iodide.

Within the scope of an additional specific embodiment, the stabilizer composition contains potassium iodide. Potassium iodide may diffuse out of the polymer matrix and be deposited on adjacent metallic areas or may react with the metal (migration effects). These compounds, which are not detectable because of their small layer thickness, have a great influence on the subsequent corrosive and reactive behavior.

Within the scope of one specific embodiment, the stabilizer composition has a molar ratio of copper halides to alkali halides, for example, of copper fluoride to alkali fluoride or of copper chloride to alkali chloride or of copper bromide to alkali bromide or of copper iodide to alkali iodide, in particular of copper(I) iodide to potassium iodide in a range from 1:3 to 1:115, for example, from 1:12 to 1:115 or from 1:17 to 1:115 and/or a weight ratio of copper halides to alkali halides, for example, of copper fluoride to alkali fluoride or of copper chloride to alkali chloride or of copper bromide to alkali bromide or of copper iodide to alkali iodide, in particular of copper(I) iodide to potassium iodide in a range of 1:2.5 to 1:100, for example, from 1:11 to 1:100 or from 1:15 to 1:100.

The stabilizer composition may contain, for example, ≧0.01 wt % to <30 wt %, in particular ≧0.01 wt % to <20 wt % (based on the total weight of the stabilizer composition) of copper halides, for example, copper(I) iodide and ≧70 wt % to ≦0.99 wt %, in particular ≧80 wt % to ≦0.99 wt % (based on the total weight of the stabilizer composition) of alkali halides, for example, potassium iodide. In particular the sum of the weight percentages of copper halides, for example, copper(I) iodide and alkali halides, for example, potassium iodide, may be 100 wt %.

The stabilizer composition is suitable in particular for stabilizing polyamides, for example, PA66.

The polymer composition according to the present invention may in particular contain a stabilizer composition according to the present invention. In this case, the proportion of the stabilizer composition in the polymer composition may amount to ≧0.01 wt % to ≦10 wt %, preferably ≧1.1 wt % to ≦10 wt % or ≧1.15 wt % to ≦10 wt %, for example, ≧1.15 wt % to ≦3.5 wt % or ≧1.65 wt % to ≦3.5 wt %, based on the total weight of the polymer composition, and/or the proportion of copper halides, for example, copper iodide of the stabilizer composition in the polymer composition may amount to ≧0.1 wt % to ≦1 wt %, in particular ≧0.15 wt % to ≦1 wt % or ≧0.2 wt % to ≦1 wt %, for example, ≧0.15 wt % to ≦0.5 wt % or ≧0.2 wt % to ≦0.5 wt %, based on the total weight of the polymer composition, and/or the proportion of alkali halides, for example, potassium iodide of the stabilizer composition in the polymer composition may amount to ≧1 wt % to ≦9 wt %, in particular ≧1.5 wt % to ≦9 wt % or ≧2 wt % to ≦9 wt %, for example, ≧1.5 wt % to ≦3 wt % or ≧2 wt % to ≦3 wt %, based on the total weight of the polymer composition.

Another subject matter of the present invention is a molded part, in particular a plastic extrusion coating, for example, a pressed screen extrusion coating for a transmission, for example, having a polymer composition according to the present invention and/or a stabilizer composition according to the present invention. The molded part may be, for example, a sheathed metal part or a sheathed metal-plastic composite, for example, a sheathed pressed screen or a part of a transmission, in particular a transmission control module.

In addition, the subject matter of the present invention is a coating method, in particular an injection molding and/or extrusion coating method, in which a metal part or a metal-plastic composite is coated and/or sheathed with a polymer composition according to the present invention and/or a polymer composition containing a stabilizer composition according to the present invention.

Furthermore, one subject matter of the present invention is the use of a polymer composition according to the present invention and/or a stabilizer composition according to the present invention. For example, a polymer composition according to the present invention and/or a stabilizer composition according to the present invention may be used to reduce the formation of conductive deposits on a metal, which is sheathed and/or coated with a suitably stabilized polymer composition. In particular a polymer composition according to the present invention and/or a polymer composition containing a stabilizer composition according to the present invention may be used as an injection molding and/or extrusion coating material, for example, as injection molding granules, in particular a pressed screen extrusion coating material.

### BRIEF DESCRIPTION OF THE DRAWINGS

FIG. 1 shows an illustration of a pressed screen sheathed with one specific embodiment of a polymer composition according to the present invention.

FIG. 2 shows an illustration of a pressed screen sheathed with a traditional amine-stabilized polymer composition.

### DETAILED DESCRIPTION

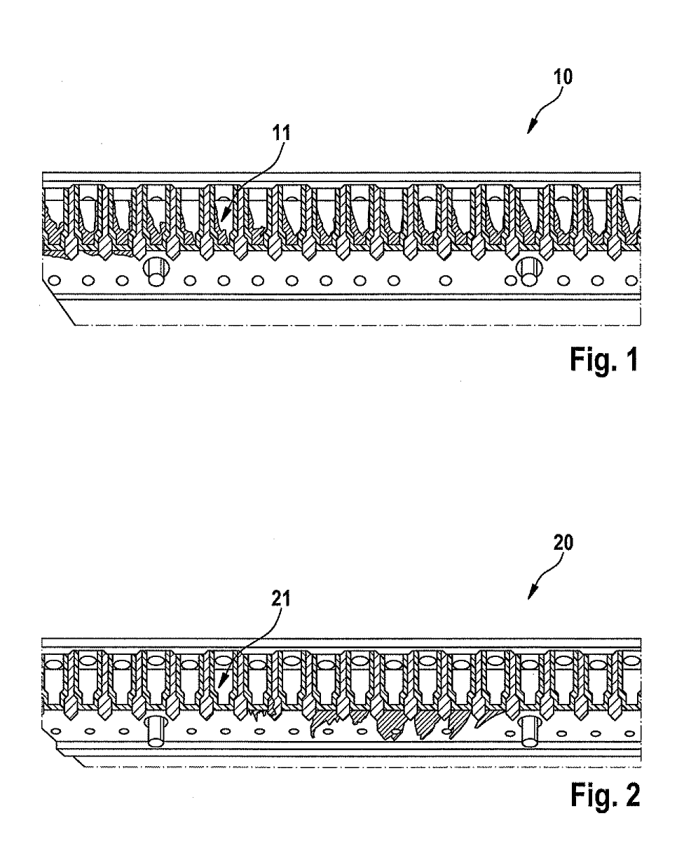

FIG. 1 shows a metallic pressed screen 10, which was sheathed using one specific embodiment of a polymer composition according to the present invention and then is stored in oil for approximately 1700 hours at a constant temperature of 150° C. The polymer composition contained polyamide PA66, 35 wt % glass fibers, 0.1 wt % copper(I) iodide and 1 wt % potassium iodide.

FIG. 2 shows a metallic pressed screen 20 obtained using a traditional amine-stabilized polyamide polymer composition and then stored in oil for approximately 1700 hours at a continuous temperature of 150° C.

FIGS. 1 and 2 show that sections 11 of pressed screen 10 sheathed according to the present invention, as shown in FIG. 1, have significantly less conductive deposits in contrast with sections 21 of traditionally extrusion coated pressed screen 20, which is shown in FIG. 2.

What is claimed is:

1. A polymer composition comprising:
at least one thermoplastic polymer;
at least one copper halide; and
at least one alkali halide.

2. The polymer composition according to claim 1, wherein the thermoplastic polymer is polyamide.

3. The polymer composition according to claim 1, wherein the polymer composition contains at least one copper(I) halide.

4. The polymer composition according to claim 1, wherein the polymer composition contains copper(I) iodide and potassium iodide.

5. The polymer composition according to claim 1, wherein a total proportion of copper halides and alkali halides in the polymer composition amounts to ≧0.01 wt % to ≦10 wt %, based on a total weight of the polymer composition.

6. The polymer composition according to claim 1, wherein at least one of:
a proportion of copper halides in the polymer composition amounts to ≧0.1 wt % to ≦1 wt %, based on a total weight of the polymer composition, and
a proportion of alkali halides in the polymer composition amounts to ≧1 wt % to ≦9 wt %, based on the total weight of the polymer composition.

7. A stabilizer composition for stabilizing thermoplastic polymers, comprising:
at least one copper halide; and
at least one alkali halide.

8. The stabilizer composition according to claim 7, wherein the thermoplastic polymers are polyamides.

9. The stabilizer composition according to claim 7, wherein the stabilizer composition contains at least one copper(I) halide.

10. The stabilizer composition according to claim 7, wherein the stabilizer composition contains copper(I) iodide and potassium iodide.

11. The stabilizer composition according to claim 7, wherein the stabilizer composition has at least one of (a) a molar ratio of copper halides to alkali halides in a range from 1:3 to 1:115 and (b) a weight ratio of copper halides to alkali halides in a range from 1:2.5 to 1:100.

12. The polymer composition according to claim 1, wherein the polymer composition is contained in a molded part.

13. The polymer composition according to claim 12, wherein the molded part is a plastic extrusion coating.

14. The polymer composition according to claim 12, wherein the molded part is a pressed screen extrusion coating.

15. The stabilizer composition according to claim 7, wherein the stabilizer composition is contained in a molded part.

16. The polymer composition according to claim 15, wherein the molded part is a plastic extrusion coating.

17. The polymer composition according to claim 15, wherein the molded part is a pressed screen extrusion coating.

18. A coating method comprising:
coating one of a metal part or a metal-plastic composite using a polymer composition, the polymer composition including at least one thermoplastic polymer, at least one copper halide and at least one alkali halide.

19. The coating method according to claim 18, wherein the method is an injection molding method.

20. The coating method according to claim 18, wherein the method is an extrusion coating method, and the coating is an extrusion coating.

21. The polymer composition according to claim 1, wherein the polymer composition is used as an injection molding material.

22. The polymer composition according to claim 1, wherein the polymer composition is used as an extrusion coating material.
